(19) United States
(12) Patent Application Publication
(10) Pub. No.: US 2015/0257038 A1
(43) Pub. Date: Sep. 10, 2015

(54) DEVICES, SYSTEMS, AND METHODS FOR SHARING NETWORK CAPACITY

(71) Applicant: Wefi, Inc., Marlborough, MA (US)

(72) Inventor: Shimon B. SCHERZER, Korazim (IL)

(73) Assignee: WeFi, Inc., Marlborough, MA (US)

(21) Appl. No.: 14/640,576

(22) Filed: Mar. 6, 2015

Related U.S. Application Data
(63) Continuation-in-part of application No. 13/921,252, filed on Jun. 19, 2013.
Application No. 13/921,252 is a continuation of application No. 13/188,723, filed on Jul. 22, 2011, now abandoned.
Application No. 13/188,723 is a continuation of application No. 11/743,853, filed on May 3, 2007, now Pat. No. 8,000,276.
Application No. 11/743,853 is a continuation-in-part of application No. 13/773,173, filed on Feb. 21, 2013.
(60) Provisional application No. 60/888,291, filed on Feb. 5, 2007.
(60) Provisional application No. 61/757,448, filed on Jan. 28, 2013.
(60) Provisional application No. 61/670,911, filed on Jul. 12, 2012.
(60) Provisional application No. 61/948,816, filed on Mar. 6, 2014.

(51) Int. Cl. H04W 28/08; H04L 12/14; G06Q 30/02; H04W 28/02

(52) U.S. Cl. CPC H04W 28/085; H04W 28/0247; H04L 12/1478; G06Q 30/0207

(57) ABSTRACT

Systems, devices, methods, and computer-readable media for connecting two operator network devices, n one implementation, a first operator network device associated with a first wireless network may communicate with a server regarding receiving (or providing) bandwidth from (or to) a second operator network device associated with a second wireless network. The first operator network device may receive from the server an identification of the second operator network device, and communicate with the second operator network device to determine at least one service providing condition. The at least one service providing condition may include identifying a first part of the service to be provided by the first operator network device and a second part of the service to he provided by the second operator network device. Thereafter, the first operator network device may provide the first part of the service, and the second operator network device may provide the second part of the service.

### RELATED APPLICATIONS

This application claims priority from U.S. Provisional Application No. 61/948,816, filed Mar. 6, 2014, which is expressly incorporated herein by reference in its entirety.

### TECHNICAL FIELD

The present disclosure relates to the field of network capacity allocation and, more particularly, devices, systems, and methods for sharing network capacity between a plurality of wireless networks.

### BACKGROUND

Cellular networks are increasingly being used for wireless Internet traffic. Such increasing amounts of wireless Internet traffic often create congestion in cellular networks. Cellular network operators often seek ways to alleviate congestion. For example, cellular network operators may attempt to alleviate congestion by increasing the cellular network's bandwidth. However, increasing a cellular network's bandwidth requires operators to invest in and deploy expensive hardware. Moreover, cellular network operators often encounter difficulties in deploying hardware in optimal locations to support the increased bandwidth.

Cellular network operators also may attempt to alleviate congestion by offloading traffic onto other networks such as, for example, a wireless local area network (i.e., “WLAN,” commonly referenced as “Wi-Fi”). One solution for providing easy access to radio networks is described in U.S. Pat. No. 8,000,276, which is incorporated herein by reference in its entirety. Yet, the bandwidth provided by a WLAN network is often not fully utilized, because is often difficult for cellular network operators to reach an agreeable arrangement with WLAN operators.

Improvements in bandwidth allocation technology are desirable.

### SUMMARY

Consistent with a disclosed embodiment, a first operator network device associated with a first network is provided. The first operator network device enables services to be provided to at least one user device at a first bandwidth. The first operator network device may include at least one processor configured to receive a request for service from the at least one user device, and to determine, based on the first bandwidth and the request, that additional bandwidth is required for providing the service to the at least one user device. The at least one processor may further transmit to a server information associated with the request, and receive from the server an identification of a second operator network device, responsive to the transmitted information. The at least one processor may further communicate with the second operator network device to determine at least one service providing condition. The at least one service providing condition may include identifying a first part of the service to be provided by the first operator network device and a second part of the service to be provided by the second operator network device. The at least one processor may enable the first part of the service to be provided to the at least one user device using the first wireless network.

Consistent with another disclosed embodiment, a first operator network device enables network services to be provided to a plurality of user devices on a first network. The first operator network device includes at least one processor configured to make a determination, based on a first bandwidth and current status of the plurality of user devices, that a second bandwidth may be provided to other user devices to, for example, improve performance, user experience, or the like. The at least one processor may transmit to a server information associated with the determination, and receive from the server an identification of a second operator network device, responsive to the transmitted information. The at least one processor may further communicate with the second operator network device to determine at least one service providing condition. The at least one service providing condition may include identifying a first part of the service to be provided by the first operator network device and a second part of the service to be provided by the second operator network device. The at least one processor may enable the first part of the service to be provided to at least one user device using the first wireless network.

Consistent with another disclosed embodiment, a server for connecting a first operator network device associated with a first wireless network to at least one second operator network device associated with a second wireless network is provided. The server may include at least one processor configured to receive from the first operator network device information associated with a request for additional bandwidth to provide service for at least one user device. The at least one processor may receive from a plurality of second operator network devices information associated with a determination that each of which may provide a second bandwidth to at least one additional user device. The at least one processor may be further use the information received from the first operator network device and the information received from the plurality of second operator network devices to select at least one second operator network device to provide additional bandwidth to the at least one user device. The at least one processor may further determine at least one service providing condition. The at least one service providing condition includes identifying a first part of the service to be provided by the first operator network device and a second part of the service to be provided by the second operator network device. The at least one processor may transmit to the first operator network device an identification of the second operator network device.

Additional aspects related to the embodiments will be set forth in part in the description which follows, and in part will be obvious from the description, or may be learned by practice of the invention.

It is to be understood that both the foregoing general description and the following detailed description are exemplary and explanatory only and are not restrictive of the invention, as claimed.

### BRIEF DESCRIPTION OF THE DRAWINGS

FIG. 1A is an illustration of an example geographical region comprising networks that may be used for implementing the disclosed embodiments.

FIG. 1B is a diagrammatic representation of an exemplary system consistent with the disclosed embodiments.

FIG. 2A is a diagrammatic representation of an exemplary WLAN operator consistent with the disclosed embodiments.

FIG. 2B is a diagrammatic representation of an exemplary cellular operator consistent with the disclosed embodiments.

FIG. 2C is a diagrammatic representation of an exemplary server consistent with the disclosed embodiments.

FIG. 3 is a flowchart showing an example method for allocating network operator capacity.

FIG. 4 is a flowchart showing an example method for placing bids on network capacity.

FIG. 5 is a flowchart showing an example method for placing revised bids on network capacity.

FIG. 6 is a diagrammatic representation of an example interface for entering bids.

FIG. 7 is a flowchart showing an exemplary method for requesting additional bandwidth from other operator network devices.

FIG. 8 is a flowchart showing an exemplary method for offering additional bandwidth to other operator network devices.

FIG. 9 is a flowchart showing an exemplary method for connecting two operator network devices.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Network capacity allocation may be performed in a number of ways. A network capacity exchange may be provided in which network capacity may be exchanged between different entities, such as, for example, between cellular network operators and WLAN operators. The network capacity exchange is configured to provide a number of functions. For example, the network capacity exchange may determine a purchase value (e.g., a recommended purchase bid, a recommended sale bid, a required purchase price, and/or a required sale price) associated with network capacity offered by an entity. The network capacity exchange may also include functionality to clear a transaction comprising the transfer of network capacity between one or more entities and/or to enforce the transaction after it has cleared.

In some embodiments, user devices may he installed with software and/or hardware that collect user-experience data, such as, for example, data regarding network speed and/or other quality data of networks that the devices connect to. These devices may operate in connection with cellular networks, WLAN networks, a combination of both, or even other network types and network combinations. Embodiments are disclosed in which, based on the network speed and/or other quality data of the networks, data derived from the network speed and/or other quality data is provided to interested entities. For example, this data may be displayed to cellular network operators and/or WLAN operators using the network capacity exchange. Moreover, embodiments are disclosed in which, based on the network speed and/or other quality data of the networks, users like the cellular network operators and/or WLAN operators purchase network capacity that the WLAN operators can supply.

Embodiments are disclosed in which an auction is provided for one or more entities purchasing network capacity and/or one or more entities selling network capacity place bids on the network capacity. In this regard, the term entity refers to one or more users individually or in a group. In such embodiments, the network capacity exchange may provide the entities purchasing network capacity with recommended purchase bids and/or may provide users selling network capacity with recommended sale bids. Entities may determine actual purchase bids and/or sale bids to place in an auction based on recommended bids. Alternatively, the network capacity exchange may provide the entities purchasing network capacity with required purchase prices and/or required sale prices. Entities may be required to place actual purchase bids and/or sale bids to place in an auction based on the required purchase prices and/or required sale prices. Based on purchase and/or sale bids received in an auction, the network capacity exchange system may allocate network capacity. In some embodiments, the network capacity exchange also or alternatively enables an entity to purchase network capacity outside of the auction environment based, for example, on the required purchase price. Moreover, the network capacity exchange also or alternatively may enable an entity to sell network capacity outside of the auction environment based, for example, on the required sale price. In addition, embodiments are disclosed in which, based on the network speed and/or other quality data of the networks, the effect of purchasing network capacity from a WLAN operator is simulated and/or measured.

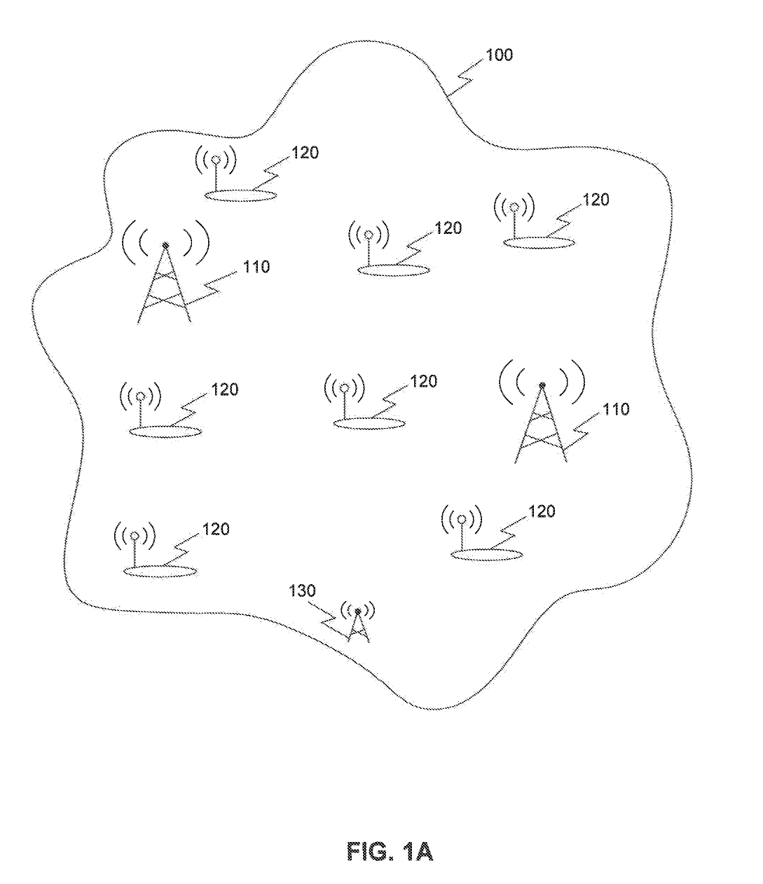

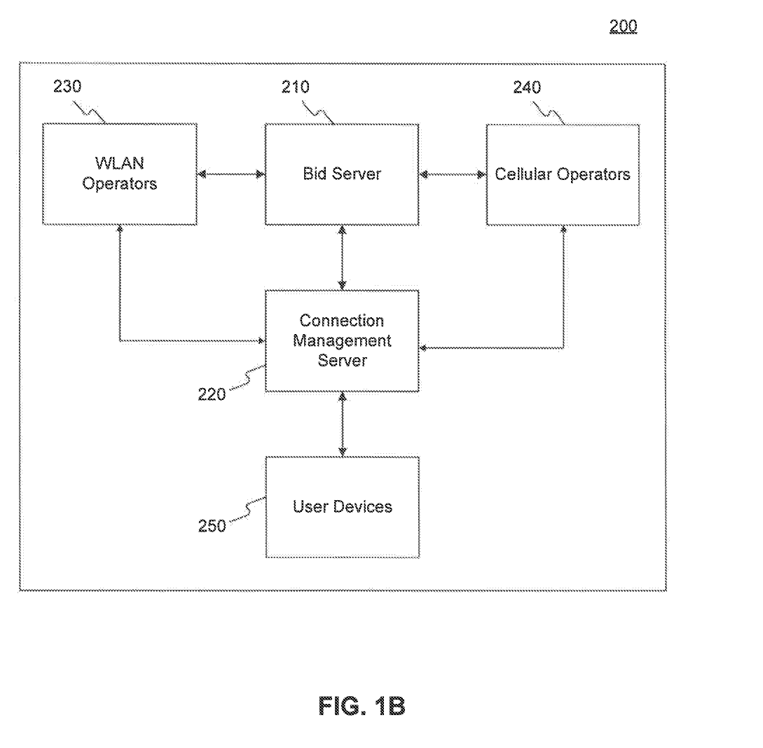

FIG. 1A is a diagram illustrating an example geographical region 100 according to some disclosed embodiments. Geographic region 100 may be, for example, an area within a city, state, or country, or any other geographical area. In some embodiments, geographical region 100 comprises a number of transceivers 110 configured to manage communications in a cellular network protocol, a number of transceivers 120 configured to manage communications in a WLAN network protocol, and a number of other transceivers, such as, for example, transceivers 130 configured to manage communications in a small cell network protocol. In some embodiments, the area serviced (i.e., the area provided wireless network coverage) by one or more cellular networks' transceivers 110, one or more WLAN networks' transceivers 120, and/or one or more other transceivers, can overlap. For example, a cellular transceiver 110 may provide cellular network coverage for a first area and a WLAN transceiver 120 may provide WLAN network coverage for a second area that at least partially overlaps the first area. Each of the one or more cellular transceivers 110 may be operated by the same cellular operator or different cellular operators. Similarly, each of the WLAN transceivers 120 may be operated by the same WLAN operator or different WLAN operators. While FIG. 1A depicts a specific number of cellular transceivers 110, WLAN transceivers 120, and small cell network transceivers 130, in some embodiments geographical region 100 includes any number of cellular transceivers 110, WLAN transceivers 120, and small cell network transceivers 130, including no cellular transceivers 110. WLAN transceivers 120, or small cell network transceivers 130.

FIG. 1B is a diagram illustrating an example network capacity management system 200 that the network capacity exchange uses to implement the disclosed embodiments. In some embodiments, system 200 includes one or more Bid Servers 210, one or more WLAN/Cellular Connection Management Servers 220, one or more WLAN Operators 230, one or more Cellular Operators 240, and one or more User Devices 250, Bid Servers 210, WLAN/Cellular Connection Management Servers 220, WLAN Operators 230, Cellular Operators 240, and User Devices 250 represent data processing apparatuses and may each include, among other things, one or more of the following components: central processing unit (CPU) configured to execute computer program code to perform various processes and methods, including the embodiments herein described; memory, such as RAM, EEPROM, and flash memory, to store data and computer program code; and an input/output device configured to enable data communication with other components.

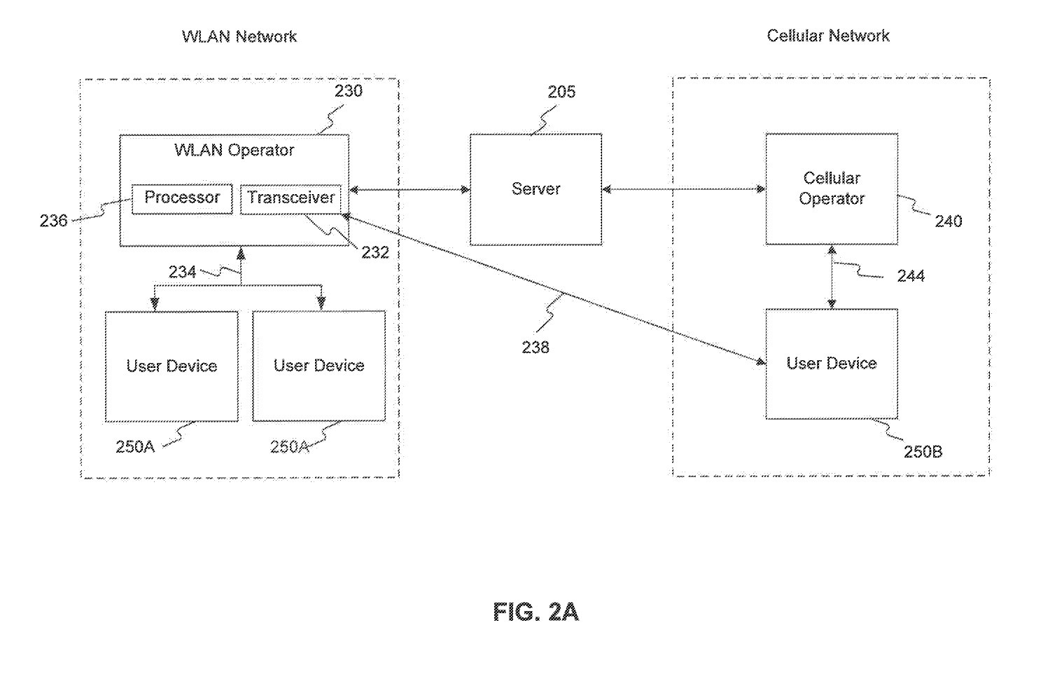

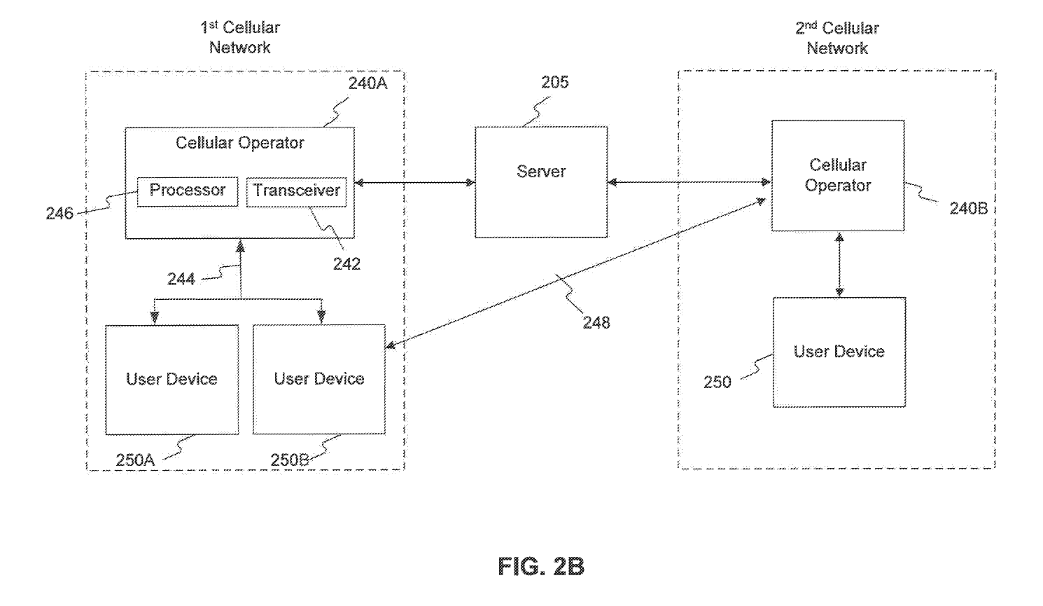

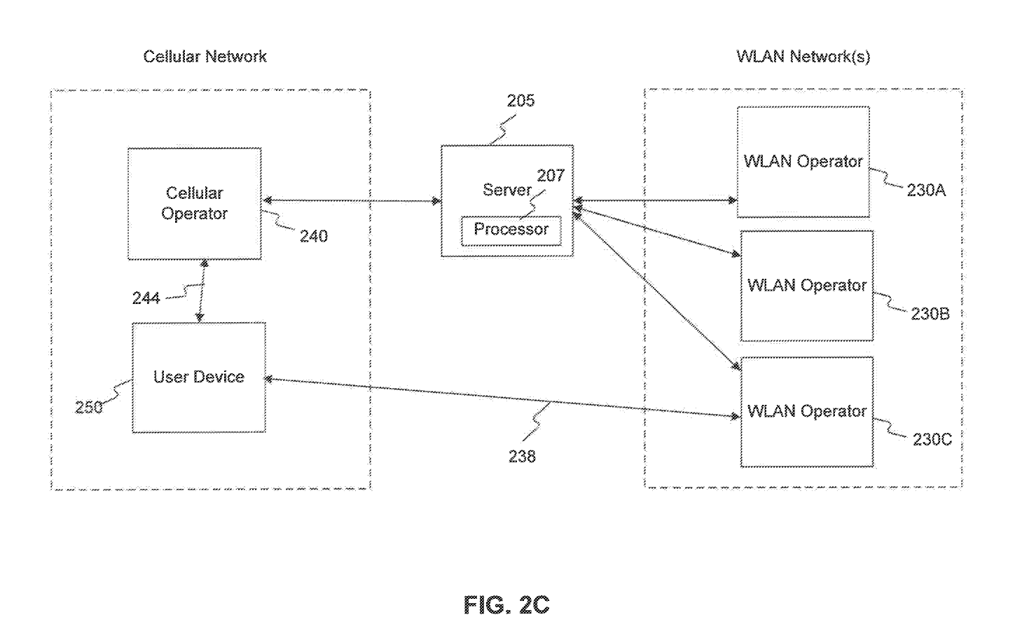

In some embodiments, each WLAN Operator 230 controls, directly or indirectly, one or more WLAN transceivers 120 and/or one or more other networks, such as one or more small cell network transceivers 130. A diagrammatic example of WLAN Operator 230 is provided in FIG. 2A. In addition, in some embodiments each Cellular Operator 240 controls, directly or indirectly, one or more cellular transceivers 110. A diagrammatic example of Cellular Operator 240 is provided in FIG. 2B In some embodiments, WLAN Operator 230 and Cellular Operator 240 communicate with Bid Server 210 and/or Connection Management Server 220 regarding network capacity allocation. Consistent with embodiments of the present disclosure Bid Server 210 and WLAN/Cellular Connection Management Server 220 may each be employed in a single server or set of servers. In other embodiments, the functionality of Bid Server 210 and WLAN/Cellular Connection Management Server 220 may be employed together in a single server. A diagrammatic example of a Server 205 having the functionality of Bid Server 210 and WLAN/Cellular Connection Management Server 220 is provided in FIG. 2C.

In some embodiments, User Devices 250 comprise hardware and/or computer program code for connecting to cellular transceivers 110, WLAN transceivers 120, and/or other networks, such as small cell network transceivers 130. In some embodiments, User Devices 250 are associated with one or more WLAN Operators 230 and/or one or more Cellular Operators 240. For example, a first set of User Devices 250 may be associated with a first Cellular Operator 240 and a second set of User Devices 250 may be associated with a second Cellular Operator 240. Moreover, in some embodiments, each User Device 250 comprises a database for storing information to enable the User Device 250 to connect to particular networks, such as cellular transceivers 110, WLAN transceivers 120, and/or small cell network transceivers 130 associated with one or more WLAN Operators 230 and/or one or more Cellular Operators 240. For example, as described in more detail in U.S. Pat. No. 8,000,276, incorporated herein by reference, User Devices 250 may comprise login information for a set of networks. In some embodiments, User Devices 250 are capable of receiving data from WLAN/Cellular Connection Management Server 220 to enable User Devices 250 to connect to networks. Moreover, in some embodiments, User Devices 250 are capable of transmitting data regarding the network speed and/or other quality data experienced when connected to one or more networks. For example, the data provided by User Devices 250 to Connection Management Server 220 may include network-usage data and network-speed data, which may be used by Connection Management Server 220 to estimate available network capacity. As used in this application, network capacity may refer to one or more of the following: the bandwidth associated with a network (e.g., the total amount of data that a network may send and/or receive), the excess bandwidth associated with a network (e.g., the difference between the total amount of data that a network may send and/or receive and the amount of data that a network actually sends and/or receives), the network speed associated with a network, and/or other communication resources associated with a network.

In some embodiments, Connection Management Server 220 provides the data provided by User Devices 250 and/or data derived from the data provided by User Devices 250 to one or more WLAN Operators 230 and/or one or more Cellular Operators 240. The one or more Cellular Operators 240 may use the data to determine a price to offer to pay for offered network capacity based on, for example, the effect of winning the additional network capacity on one or more cellular networks and the estimated willingness of the WLAN Operator associated with the offered network capacity to sell the network capacity. The one or more WLAN Operators 230 may use the data to determine a price to offer to sell offered network capacity based on, for example, the effect of selling the network capacity on one or more WLAN networks and the estimated willingness of the one or more Cellular Operators 240 to buy the network capacity.

FIGS. 2A-2C illustrate examples of a first operator network device communicating with a second operator network device. In the context of this disclosure, the term “second operator network device” refers to a device external to the wireless network associated with the first operator network device. For example, a WLAN operator may be considered as a second operator network device to a cellular operator because the WLAN operator is not part of the cellular network. The second operator network device may utilize a different technology of the first operator network device. Alternatively, the second operator network device may utilize the same technology but a different service provider. Also, according to some embodiments of this disclosure, the communication of the first operator network device with second operator network device may occur using intermediation of a server.

FIG. 2A is a block diagram illustrating the components of a first operator network device according to one embodiment, in the example shown in FIG. 2A the first operator network device is a WLAN Operator 230 and the second operator network device is a Cellular Operator 240. WLAN Operator 230 may enable providing wireless services to a plurality of User Devices 250A using a first bandwidth. The first bandwidth may depend on current conditions of the WLAN network. In one embodiment, WLAN Operator 230 may include at least one transceiver 232. Arrow 234 reflects the wireless services provided to the plurality of User Devices 250A using the first bandwidth. WLAN Operator 230 may further include a processor 236 configured to make a determination, based on the first bandwidth and current status of the plurality of User Devices 250A, that a second bandwidth may be provided to at least one other user device. WLAN Operator 230 may transmit to Server 205 information associated with the determination. In one embodiment, the transmitted information enables Server 205 to select a second operator network device associated with a second wireless network (for example, Cellular Operator 240) that requires additional bandwidth for providing service to User Device 250B. The additional bandwidth, required by Cellular Operator 240, may be less than the second bandwidth.

Thereafter, WLAN Operator 230 may receive from Server 205 an identification of the Cellular Operator 240, and communicate with Cellular Operator 240 to determine at least one service providing condition. The at least one service providing condition may include identifying a first part of the service to be provided by WLAN Operator 230 and a second part of the service to be provided by Cellular Operator 240. According to the at least one service providing condition the WLAN Operator 230 may provide the first part of the service to User Device 250B. Arrow 238 reflects the part of wireless service provided to User Device 250B by WLAN Operator 230, and arrow 244 reflects the part of wireless service provided to User Device 250B by Cellular Operator 240.

Although the example in FIG. 2A refers to a WLAN operator device that provides additional bandwidth to a cellular operator device, the present disclosure is not limited to any wireless network or any communication standard. Embodiments consistent with the disclosure may enable a network operator device that uses one or more of the following exemplary communication standards: GSM, Edge, LTE, CDMA, Wimax, WiFi, Bluetooth, and Satellite BGAN. In addition, embodiments of the disclosure may employ network operator devices that use other known or future wireless protocols. In one embodiment, the technology supporting the first wireless network may be similar to the technology supporting the second wireless network. For example, two WLAN operator devices may provide different parts of service to one User Device 250. Alternatively, the technology supporting the first wireless network may be different from a technology supporting the second wireless network. For example, the first wireless network's technology maybe WLAN (e.g., WiFi) and the second wireless network's technology may be cellular (e.g., GSM).

FIG. 2B is a block diagram illustrating the components of a first operator network device, according to anther embodiment. In the example shown in FIG. 2B the first operator network device is a Cellular Operator 240A that is associated with a first cellular network and the second operator network device is a Cellular Operator 240B that is associated with a second cellular network. Cellular Operator 240A may enable providing wireless services to a plurality of user devices (e.g., User Device 250A and User Device 250B) at a first bandwidth, wherein the first bandwidth depends at least on current conditions of the first cellular network. In one embodiment Cellular Operator 240A may include at least one transceiver 242. Arrow 244 reflects the wireless services provided to the plurality of User Device 250 at a first bandwidth. Cellular Operator 240A may further include a processor 246 configured to receive a request (or a plurality of requests) for service from the plurality of User Device 250 (e.g., from User Device 250B). Processor 246 may determine, based on the first bandwidth and the request, that additional bandwidth is required. Cellular Operator 240A may transmit to Server 205 information associated with the request. In one embodiment, the information transmitted enables Server 205 to select a second operator network device associated with a second wireless network (for example, Cellular Operator 240B) to provide the additional bandwidth.

Thereafter, Cellular Operator 240A may receive from Server 205 an identification of Cellular Operator 240B, and communicate with the Cellular Operator 240B to determine at least one service providing condition. The at least one service providing condition may include identifying a first part of the service to be provided by Cellular Operator 240A and a second part of the service to be provided by Cellular Operator 240B. Cellular Operator 240A may provide the first part of the service User Device 250B according to the at least one service providing condition. Arrow 244 reflects the part of wireless service provided to User Device 250B by Cellular Operator 240A, and arrow 248 reflects the part of wireless service provided to User Device 250B by Cellular Operator 240B.

Similar to the embodiment depicted in FIG. 2A, the embodiment demonstrated in FIG. 2B is not limited to any wireless network of the operator devices. In the example in FIG. 2B, both network operator devices are cellular operators, however, other wireless networks (e.g., WLAN or satellite) may provide the second part of the service. In some embodiments, Cellular Operator 240A may receive from User Device 250 feedback on the second part of the service provided by Cellular Operator 240B, and may transmit quality report to Server 205. The quality reports may be used by Server 205 to select the proper second operator network device to provide the additional bandwidth, and to determine the at least one service providing condition.

Consistent with some embodiments of the present disclosure, the information transmitted to Server 205 may include information originated from User Device 250B. For example, the information at least one of: uplink data usage, downlink data usage, Service Set Identifiers (SSIDs) of multiple operator network devices in a proximity to a user device, signal strengths of the multiple operator network devices, throughput, and location. Consistent with other embodiments, the information transmitted to Server 205 may include information originated from Cellular Operator 240A. For example, offloading policies and user experience target settings.

FIG. 2C is a Hock diagram illustrating the components of Server 205 for connecting a first operator network device associated with a first wireless network (for example, Cellular Operator 240) to one or more second operator network devices associated with one or more second wireless networks (for example, WLAN Operators 230A and 230B may be part of the same second wireless network, and 230C may be part of a different second wireless network). According to several embodiments, Server 205 may include a processor 207 configured to receive from Cellular Operator 240 information associated with a request for additional bandwidth to provide service for User Device 250, and from each of the plurality of WLAN Operators 230 information associated with a determination that each of the WLAN Operators 230 can provide a second bandwidth to other User Devices 250. Processor 207 may use the information received from Cellular Operator 240 and the information received from the plurality of WLAN Operators 230 to select a WLAN Operator 230C for providing additional bandwidth to User Device 250.

The selection of the WLAN Operator 230C may be based on predefined conditions from Cellular Operator 240 and/or based on quality reports of the plurality of the WLAN Operators 230. In addition, processor 207 may determine at least one service providing condition, and transmit to Cellular Operator 240 an identification of the WLAN Operator 230. In the example depicted in FIG. 2C, arrow 238 reflects the part of wireless service provided to User Device 250 by the selected WLAN Operator 230, and arrow 244 reflects the part of wireless service provided to User Device 250 by Cellular Operator 240. In some embodiments, Server 205 may receive information associated with requests of a plurality of User Devices 250, each requires additional bandwidth. Server 250 may select one or more operator network devices to provide the additional bandwidth to the plurality of User Devices 250.

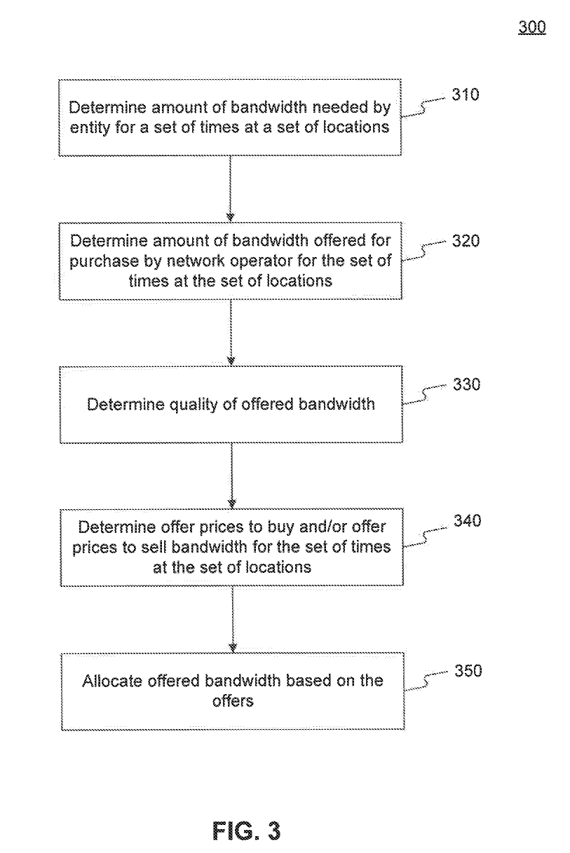

FIG. 3 depicts an example method 300 for allocating network operator network capacity. In some embodiments method 300 may be implemented as one or more computer programs. Method 300 begins with a determination of the amount of network capacity needed by one or more entities, such as Cellular Operators 240, at one or more times and at one or more locations (step 310). In this regard, a location refers to a coverage area, each coverage area contains one or more wireless transceivers positioned at one or more locations within the coverage area as shown, for example, in FIG. 1A.

For example, traffic load on a cellular network may vary with time and location. For example, the cellular traffic load in downtown Manhattan may reach unsustainable levels on a specific cellular network between 4 p.m. and 6 p.m., whereas the cellular traffic load at the same location may be relatively low and sustainable on the cellular network between 10 a.m. and 1 p.m. Thus, in this example, a determination may be made that no additional network capacity is needed in downtown Manhattan between 10 a.m. and 1 p.m., whereas some additional network capacity is needed between 4 p.m. and 6 p.m. In some embodiments, the amount of network capacity that one or more Cellular Operators 240 use and/or need at various times and locations is determined based on data provided by User Devices 250, such as, for example, user-experience data as described in FIG. 1B above.

In some embodiments, a determination is made of the amount of network capacity that is offered by one or more other entities, such as one or more WLAN Operators 230, at one or more times and at one or more locations (step 320). For example, the traffic load on a WLAN network at a particular location may be relatively light during some times and relatively heavy at other times. In some embodiments, the amount of network capacity that a MAN Operator 230 can commit to provide at various times and locations is determined based on data provided by User Devices 250, such as, for example, user-experience data as described in FIG. 1B above.

In some embodiments, a determination is made of the quality of the network capacity that is offered (step 330). For example, the quality may be determined based on data provided by User Devices 250, such as, for example, user-experience data as described in FIG. 1B above. For example, if User Devices 250 provide data indicating that the network capacity has previously been associated with relatively slow speeds, a low quality rating may be determined, whereas if the User Devices 250 provide data indicating that the network capacity has previously been associated with relatively high speeds, a high quality rating may be determined. Thus, for example, past quality associated with the offered network capacity may be used to estimate expected quality, in some embodiments, if the quality of the offered network capacity is not sufficiently high, no bidding will be performed on the network capacity. In some embodiments, the quality of the offered network capacity affects the network capacity's price.

In some embodiments, a determination is then made of one or more offer prices to buy network capacity at a set of times and locations and/or one or more offer prices to sell network capacity at the set of times and locations (step 340). In some embodiments, each bid comprising an offer to buy network capacity or an offer to sell network capacity may be associated with a coverage element. A coverage elements includes, for example, a location (e.g., a particular geographical region serviced by a carrier), a time frame (e.g., a set of times of a day and/or a set of days of a week), and/or a purchase lifetime (e.g., a commitment period during which network capacity remains allocated in accordance with an auction's results).

In some embodiments, a recommended offer price to buy or sell network capacity at a given time and location may be determined using the equation:

$$Min\_offer \_bid ( Mbye ) = Mbyte\_production \_cost \_at \_location / time \cdot {K}_{c} \cdot {K}_{w} , \\ where$$

$${K}_{c} = \frac{Mean\_Cell \_data \_speed}{Actual\_Cell \_data \_speed \_at \_location / time} , \\ and$$

$${K}_{w} = \frac{Mean\_WiFi \_data \_speed}{Actual\_data \_WiFi \_speed \_at \_location / time} ,$$

wherein Mbyte₁₃ production_cost_at_location/time represents the cost of producing additional network capacity at a given location and time, Mean_Cell_data_speed represents the mean data speed that a cellular network can provide, Actual_Cell_data_speed_at_location/time represents the data speed that a cellular network can provide at a given location and time, Mean_WiFi_data_speed represents the mean data speed that a WLAN network can provide, and Actual_data_WiFi_speed_at_location/time represents the data speed that a WLAN network can provide at a given location and time.

Thus, for example, as the actual data speed provided by a Cellular Operator 240 at the time and location decreases, the offer price to buy or sell network capacity and the time and location may increase. Similarly, for example, as the actual data speed provided by a WLAN Operator 230 at the time and location decreases (an indication of short supply), the offer price to buy or sell network capacity and the time and location may increase. In alternative embodiments, other formulas can also be used to determine offer prices to purchase or sell network capacity. For example, additional variables, such as a quality parameter, may also affect the offer prices.

In some embodiments, the offer prices are automatically adopted. For example, a Cellular Operator 240 may agree to always purchase network capacity for a coverage element for its offer price. Similarly, for example, a WLAN Operator 230 may agree to always sell network capacity for a coverage element for its offer price.

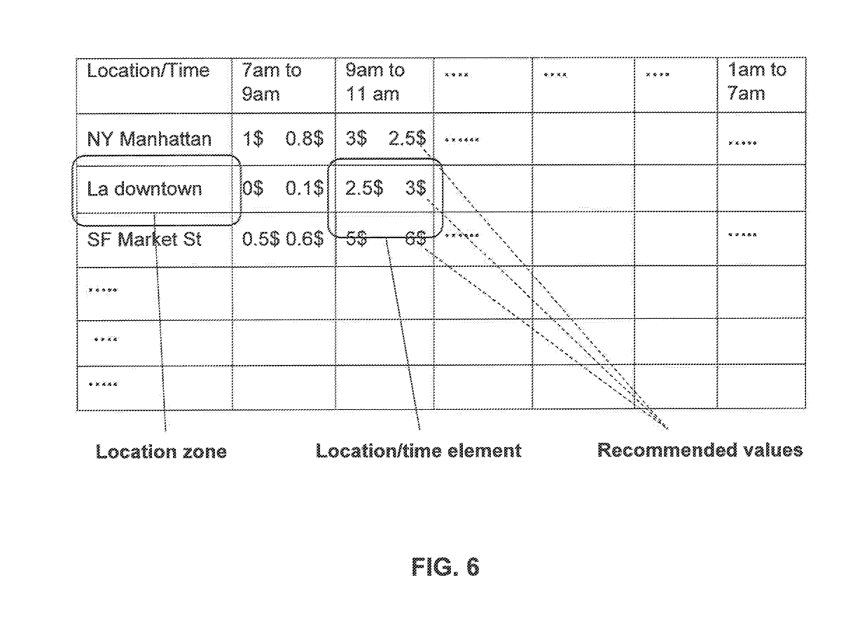

In other embodiments, a purchasing or selling entity chooses whether to adopt or revise an offer price. For example, an interface, as depicted in FIG. 6, with various locations and various times may be provided by Bid Server 210 and interacted with by a Cellular Operator 240 using, for example, a user interface. The interface may initially he populated with recommended bids for purchasing network capacity at various times and locations or may initially be empty and require the one or more Cellular Operators 240 to enter bids. Regardless of whether the matrix is populated with recommended bids, a Cellular Operator 240 may enter additional bids, such as, for example, bids that deviate from the recommended bids based on other factors such as competition from other Cellular Operators 240. In some embodiments, the one or more Cellular Operators 240 may choose to ignore some times and/or locations. The one or more WLAN Operators 230 may enter offer prices to sell network capacity in substantially the same manner as the one or more Cellular Operators 240 enter offer prices to buy network capacity. In some embodiments, however, each of the one or more WLAN Operators 230 can only enter offer prices to sell network capacity for locations in which the WLAN Operator 230 has networks providing service.

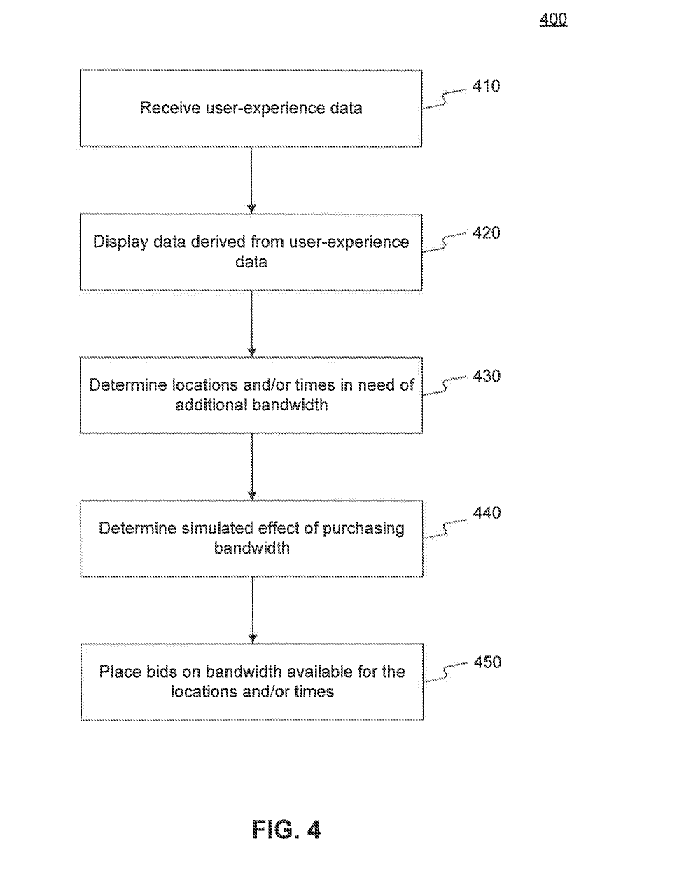

FIG. 4 depicts an exemplary method 400 for placing bids on network capacity. In some embodiments method 400 may be implemented as one or more computer programs. Method 400 begins by receiving user-experience data (step 410). For example, Connection Management Server 220 may receive user-experience data from user devices 250. In some embodiments, data is displayed to one or more Cellular Operators 240 and/or one or more WLAN Operators 230 based on the user-experience data (step 420). For example, a map of a geographic region overlaid with a Cellular Operator's user density distribution may be displayed. Similarly, for example, a map of a geographic region overlaid with a Cellular Operator's network capacity distribution may be displayed. In some embodiments, a user can interact with the map such as by, for example, zooming in, zooming out, or panning in any direction.

In some embodiments, the displayed data is used to identify one or more locations and times in need of additional network capacity (step 430). For example, a Cellular Operator 240 may determine that at a given location at a given time, the network capacity used is too high based on the displayed map. In some embodiments, networks associated with a WLAN Operator 230 near the determined location are displayed. For example, a Cellular Operator 240 may draw the boundaries of a region on the map in need of additional network capacity. Then, for example, networks associated with a WLAN Operator 230 that service at least some of the region defined by the Cellular Operator 240 may be displayed. In some embodiments, the network capacity available from such networks on average and/or at a particular time is also displayed.

In some embodiments, the effect of purchasing network capacity from a particular network is simulated (step 440). For example, the network capacity that the network can provide at various areas may be subtracted from the displayed network capacity distribution. Such subtraction may take into account the likelihood that a User Device 250 will connect to the network. For example, at a particular location, the network capacity that the network can provide may be multiplied by the probability that the User Device 250 will choose the network before subtracting the resulting value from the displayed network capacity distribution. In one example, the effect of purchasing network capacity from additional networks is simulated. A Cellular Operator 240 may, for example, utilize the simulation to determine whether to bid on the network capacity that the network can provide. In some embodiments, WLAN Operators 230 and/or Cellular Operators 240 place bids on the available network capacity in substantially the same manner as described above with regard to steps 310-350 of FIG. 3 (step 450).

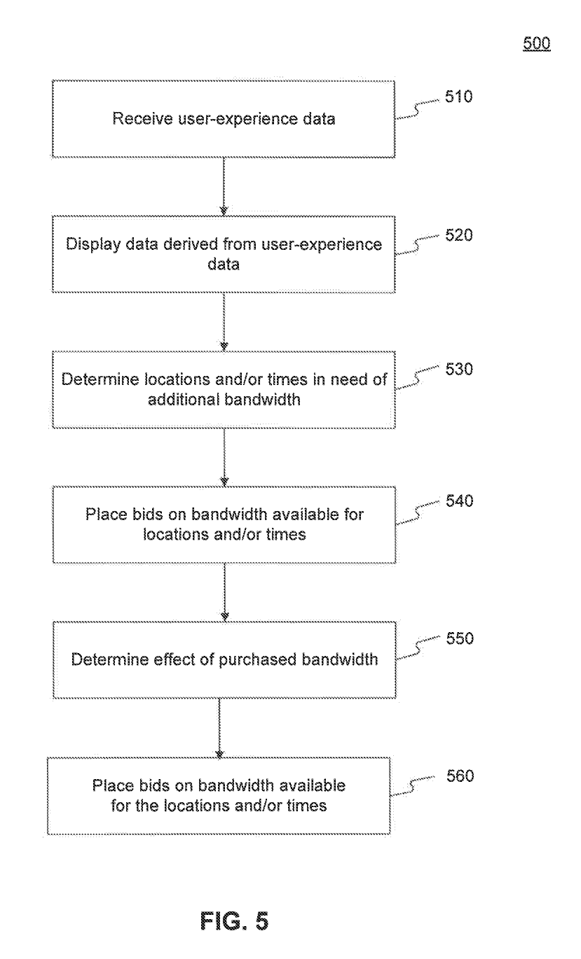

FIG. 5 depicts an example method 500 for placing bids on network capacity. In some embodiments method 500 may be implemented as one or more computer programs. Steps 510-530 of method 500 are performed in substantially the same manner as steps 410-430 of FIG. 4. In addition, in some embodiments, WLAN Operators 230 and/or Cellular Operators 240 place bids on the network capacity in substantially the same manner as described above with regard to steps 310-350 of FIG. 3 (step 540).

In some embodiments, after allocating the network capacity to Cellular Operator 240 for a coverage element, the effect of allocating the network capacity is determined (step 550). For example, the effect may be determined based on user-experience data received by Connection Management Server 220 from User Devices 250. In some embodiments, the user-experience data is used to derive past experience data to store in Bid Server 210 and associate with the WLAN Operator 230 associated with the allocated network capacity. For example, as described above, if the user-experience data indicates that the wireless network associated with the allocated network capacity had a low quality, WLAN Operator 230 may be associated with a low rating for past experience. Additionally, for example, if the user-experience data indicates that the actual network capacity of the wireless network associated with the allocated network capacity deviated from the offered network capacity by more than a predetermined amount, WLAN Operator 230 may be associated with a low rating for past experience.

In some embodiments, WLAN Operators 230 and/or Cellular Operators 240 can then place revised bids on the network capacity based on the actual effect of the network capacity (step 560). For example, as described above, the past experience data associated with the WLAN Operator 230 associated with the previously allocated network capacity may be used to adjust bids from other WLAN Operators and/or Cellular Operators 240 (including, but not limited to, a Cellular Operator 240 that had purchased the previously allocated available network capacity) for network capacity offered by the WLAN Operator 230 up or down and/or to weight bids from other WLAN Operators and/or Cellular Operators 240 for network capacity offered by WLAN Operator 230 up or down. In some embodiments, only bids associated with the particular wireless network associated with a past experience are adjusted or weighted based on the past experience. In other embodiments, bids associated with some or all of the wireless networks offered by WLAN Operator 230 are adjusted or weighted based on a past experience associated with a wireless network offered by the WLAN Operator 230.

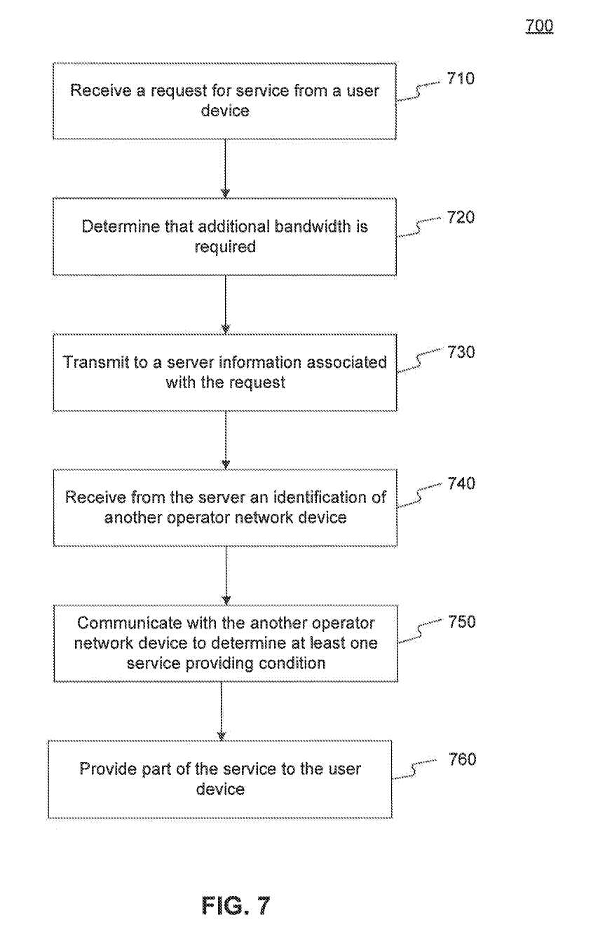

FIG. 7 depicts an exemplary method 700 for requesting additional bandwidth from other operator network devices. In some embodiments method 700 may be implemented by a first operator network device associated with a first wireless network (e.g., WLAN Operator 230 or Cellular Operator 240) and using one or more computer programs. The first operator network device may enable providing wireless services to at least one user device at a first bandwidth, when the first bandwidth depends at least on current conditions of the first wireless network. In step 710, the first operator network device may receive a request for service from a user device. The term “service” refers to any service for the end user of the user device and includes, for example, video conferences, multimedia sessions, file delivery services, web surfing network gaming, database access, or similar services that require a relative high bandwidth.

In step 720, the first operator network device may determine, based on the request and the first bandwidth, that additional bandwidth may be required. In some cases, the additional bandwidth may be required in order to comply with specific needs or requests of the end user. For example, a user may wish to watch a video stream in high definition. In step 730, the first operator network device may transmit to a server information associated with the request. In some embodiments, the information transmitted to the server may include a suggested or recommended compensation associated with bandwidth to be provided (for example, a recommended purchase bid). The suggested compensation may include a desired purchase value and/or a threshold purchase value.

In step 740, the first operator network device may receive from the server an identification of a second operator network device. The second operator network device may be associated with a second wireless network. The identification of the second operator network device may include an offer for compensation associated with the bandwidth to be provided (for example, a recommended sale bid, or a required sale price). In some cases the offer for compensation may include a proposed purchase value from the second operator network device or an agreed purchase value determined by the server. Consistent with other embodiments, the first operator network device may receive from the server an identification of a plurality of second operator network devices. The first operator network device may determine to use one or more of the second operator network devices for providing the additional bandwidth.

In step 750, the first operator network device may communicate with the second operator network device to determine at least one service providing condition. In some embodiments the at least one service providing condition may include an agreed purchase value for providing part of the service by the second operator network device using the second wireless network. The agreed purchase value may be determined in an auction, as described above, in addition, the agreed purchase value may be less than it would cost to provide the part of the service by a different first operator network device, for example, a different first operator network device of the first wireless technology. In other embodiments, the at least one service providing condition may include identifying a first part of the service to be provided by the first operator network device and a second part of the service to be provided by the second operator network device.

In step 760, the first operator network device may enable providing part of the service to the user device. For example, the first operator network device may enable providing the first part of the service to the user device, while the second operator device may enable providing the second part of the service to the user device. The term “enable providing service” means that the first operator network device and the second operator device do not necessarily provide the service themselves, but may instruct other entities in the wireless network (e.g., base stations, gateways, access point, etc.) to provide at least part of the service.

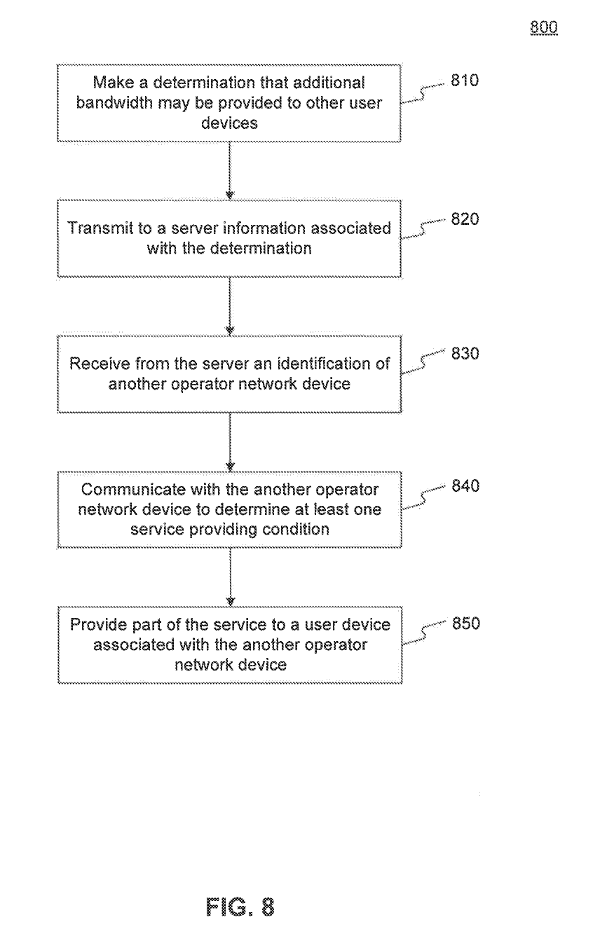

FIG. 8 depicts an example method 800 for offering additional bandwidth to second operator network device. In some embodiments method 800 may be implemented by a first operator network device associated with a first wireless network (e.g., WLAN Operator 230 or Cellular Operator 240) as one or more computer programs. The first operator network device may enable providing wireless services to a plurality of user devices using a first bandwidth, when the first bandwidth depends at least on current conditions of the first wireless network. In step 810, the first operator network device may make a determination, based on the first bandwidth and current status of the plurality of user devices that a second bandwidth may be provided to other user devices. The current status of the plurality of user devices may include the number of user devices that hibernate and the number of user device that operate. Additionally, the current status of the plurality of user devices may include a current prediction of the bandwidth to be used by the plurality of users in the near future (the next hour, the next 3 hours, the rest of the day) based on the current service being provided.

In step 820, the first operator network device may transmit to a server information associated with the determination. In some embodiments, the information transmitted to the server may include an offer for compensation associated with bandwidth to be provided (for example, a recommended sale bid). The offer for compensation may include a proposed sale value and a threshold sale value. In other embodiments, the information transmitted to the server may include at least one of: target revenue, target user experience metrics, and network connection information.

In step 830, the first operator network device may receive from the server an identification of a second operator network device associated with a second wireless network. The second operator network device may require additional bandwidth for providing service to at least one user device. In some embodiments, the identification of the second operator network device may also include a suggested compensation associated with bandwidth to be provided (for example, a recommended purchase bid, or a required purchase price). The suggested compensation may include a proposed purchase value from the second operator network device or an agreed purchase value determined by the server.

In step 840, the first operator network device may communicate with the second operator network device to determine at least one service providing condition. In some embodiments, the at least one service providing condition may include an agreed purchase value for providing part of the service by the first operator network device using the first wireless technology. In other embodiments, the at least one service providing condition may include identifying a first part of the service to be provided by the first operator network device and a second part of the service to be provided by the second operator network device.

In step 850, the first operator network device may enable providing part of the service to a user device associated with the second operator network device. For example, the first operator network device may enable providing the first part of the service to the user device, and the second operator network device may enable providing the second part of the service to the user device.

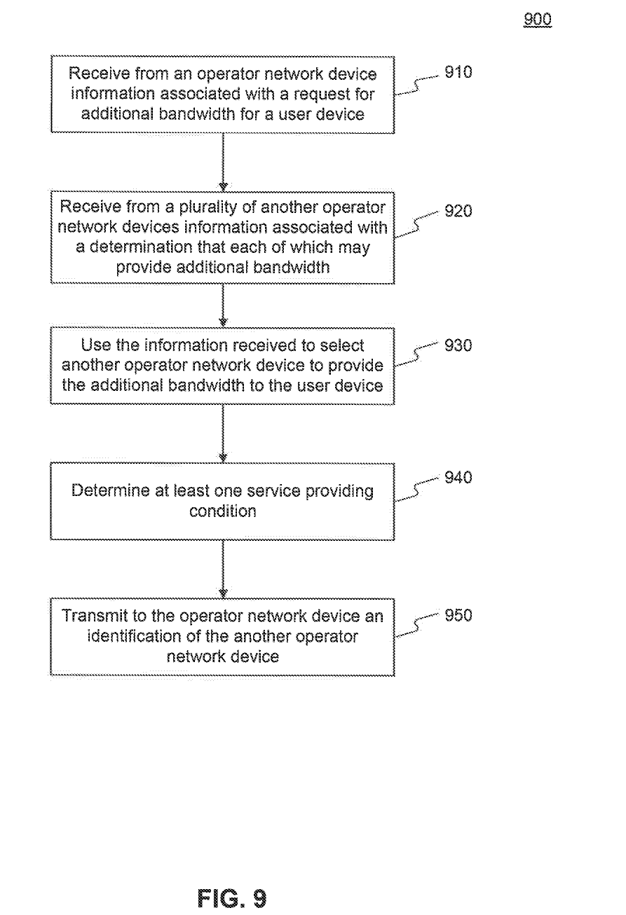

FIG. 9 depicts an exemplary method 900 for connecting two for more) operator network devices. In some embodiments method 900 may be implemented by a server (for example, Server 205) as one or more computer programs. In step 910, the server may receive, from a first operator network device being part of a first wireless network, information associated with a request for additional bandwidth for at least one user device. The information received from the first operator network device may include an indication of how much additional bandwidth is required and a suggested compensation for the bandwidth to be provided (for example, a recommended purchase bid).

In step 920, the server may receive, from a plurality of second operator network devices being part of one or more second wireless networks, information associated with a determination that each of which may provide additional bandwidth. The information received from each of the plurality of second operator network devices may include an offer for compensation associated with bandwidth to be provided (for example, a recommended sale bid).

In step 930, the server may use the information received to select a second operator network device (being part of a second wireless network) to enable providing the additional bandwidth to the at least user device (currently receives service by the first wireless network). The server may further select the second operator network device using quality reports based on data provided by user devices, such as, for example, user-experience data. Consistent with other embodiments, the server may select two or more second operator network devices to provide the additional bandwidth to the at least one user device.

In step 940, the server may determine at least one service providing condition. In some embodiments, the at least one service providing condition may include an agreed purchase value for providing part of the service to the at least one user device by the second wireless network. In other embodiments, the at least one service providing condition may include identifying a first part of the service to be provided by the first operator network device and a second part of the service to be provided by the second operator network device. In step 950, the server may transmit to the first operator network device an identification of the second operator network device.

Embodiments and all of the functional operations described in this specification can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine readable propagated signal, for execution by, or to control the operation of, data processing apparatus.

The term “data processing apparatus” (also referred to as a processor) encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, which is generated to encode information for transmission to suitable receiver apparatus.

The term “service providing condition” includes any logical arrangements applicable for provisioning wireless services. For example, the service providing condition may be related to transmission parameters, service quality parameters, pricing of network capacity, and more. In some embodiments, the service providing condition may be used to integrate and regulate the work of two (or more) operator network devices, such that they can provide different parts of service to at least one user device. One or more service providing conditions may be determined by server (e.g., Server 205) that connects the two (or more) operator network devices. For example, Server 205 may determine the final price of network capacity provided by the second operator network device. In other embodiments, at least one service providing condition may be determined by each of the two (or more) operator network devices. For example, the minimal QoS for the service.

A computer program (also referred to as a program, software, an application, a software application, a script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification (e.g., FIGS. 3-5) can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client/server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

1. A first operator network device associated with a first wireless network configured to enable wireless services to be provided to at least one user device at a first bandwidth, the first operator network device comprising at least one processor configured to:
receive a request for service from the at least one user device; determine, based on the first bandwidth and the request, that additional bandwidth is required for providing the service to the at least one user device;
transmit to a server information associated with the request;
receive from the server an identification of a second operator network device associated with a second wireless network, responsive to the transmitted information;
communicate with the second operator network device to determine at least one service providing condition, wherein the at least one service providing condition includes identifying a first part of the service to be provided by the first operator network device and a second part of the service to be provided by the second operator network device; and
enable the first part of the service to be provided to the at least one user device using the first wireless network.

2. The operator network device of claim 1, wherein a technology supporting the first wireless network is different from a technology supporting the second wireless network.

3. The operator network device of claim 1, wherein the first wireless network includes a cellular network and the second wireless network includes a Wireless Local Area Network (WLAN).

4. The operator network device of claim 1, wherein the information transmitted to the server enables the server to select the second operator network device for providing the additional bandwidth.

5. The operator network device of claim 1, wherein the information transmitted to the server includes information originated from the at least one user device or the first operator network device.

6. The operator network device of claim 5, wherein the information originated from the at least one user device includes at least one of: uplink data usage, downlink data usage, Service Set Identifiers (SSIDs) of multiple operator network devices in a proximity to a user device, signal strengths of the multiple operator network devices, throughput, and location.

7. The operator network device of claim 5, wherein the information originated from the first operator network device includes at least one of: offloading policies and user experience target settings.

8. The operator network device of claim 1, wherein the at least one processor is further configured to receive from the at least one user device feedback on the second part of the service provided by the second operator network device, and to transmit quality report to the server.

9. The operator network device of claim 1, wherein the communication between the first operator network device and the second operator network device to determine the at least one service providing condition is via the server.

10. The operator network device of claim 1, wherein the at least one processor is further configured to transmit to the server information associated with requests of a plurality of user devices, each requiring additional bandwidth, thus enabling the server to select one or more second operator network devices to provide the additional bandwidth to the plurality of user devices.

11. A first operator network device associated with a first wireless network configured to enable wireless services to be provided to a plurality of user devices at a first bandwidth, the first operator network device comprising at least one processor configured to:
make a determination, based on the first bandwidth and current status of the plurality of user devices, that a second bandwidth may be provided to other user devices;
transmit to a server information associated with the determination;
receive from the server an identification of a second operator network device associated with a second wireless network, responsive to the transmitted information;
communicate with the second operator network device to determine at least one service providing condition, wherein the at least one service providing condition includes identifying a first part of the service to be provided by the first operator network device and a second part of the service to be provided by the second operator network device; and
enable the first part of the service to be provided to at least one user device using the first wireless network.

12. The operator network device of claim 11, wherein a technology supporting the first wireless network is different from a technology supporting the second wireless network.

13. The operator network device of claim 11, wherein the first wireless network includes a Wireless Local Area Network (WLAN) and the second wireless network includes a cellular network.

14. The operator network device of claim 11, wherein the information transmitted to the server enables the server to select the second operator network device that requires additional bandwidth for providing service to the at least one user device.

15. The operator network device of claim 11, wherein the additional bandwidth, required by the second operator network device, is less than the second bandwidth.

16. The operator network device of claim 11, wherein the communication between the first operator network device and the second operator network device to determine the at least one service providing condition is via the server.

17. A server for connecting a first operator network device associated with a first wireless network to at least one second operator network device associated with a second wireless network, the server comprising at least one processor configured to:
receive from the first operator network device information associated with a request for additional bandwidth to provide service for at least one user device;
receive from a plurality of second operator network devices information associated with a determination that each of which may provide a second bandwidth to at least one additional user device;
use the information received from the first operator network device and the information received from the plurality of second operator network devices to select at least one second operator network device to provide additional bandwidth to the at least one user device;
determine at least one service providing condition, wherein the at least one service providing condition includes identifying a first part of the service to be provided by the first operator network device and a second part of the service to be provided by the second operator network device; and
transmit to the first operator network device an identification of the second operator network device.

18. The operator network device of claim 1, wherein the information transmitted to server includes a recommended compensation associated with bandwidth to be provided.

19. The operator network device of claim 18, wherein the recommended compensation includes a desired purchase value and a threshold purchase value.

20. The operator network device of claim 1, wherein the identification of the second operator network device includes an offer for compensation associated with bandwidth to be provided.

21. The operator network device of claim 20, wherein the offer for compensation includes a proposed purchase value from the second operator network device or an agreed purchase value determined by the server.

22. The operator network device of claim 1, wherein the at least one service providing condition includes an agreed purchase value for providing the second part of the service by the second operator network device using the second wireless technology.

23. The operator network device of claim 22, wherein the agreed purchase value is less than it would cost to provide the second part of the service by a different first operator network device using the first wireless technology.

24. The operator network device of claim 11, wherein the information transmitted to server includes an offer for compensation associated with bandwidth to be provided.

25. The operator network device of claim 24, wherein the offer for compensation includes a proposed purchase value and a threshold purchase value.

26. The operator network device of claim 11, wherein the identification of the second operator network device includes a recommended compensation associated with bandwidth to be provided.

27. The operator network device of claim 26, wherein the recommended compensation includes a proposed purchase value from the second operator network device or an agreed purchase value determined by the server.

28. The operator network device of claim 11, wherein the information transmitted to server includes at least one of: target revenue, target user experience metrics, and network connection information.

29. The operator network device of claim 11, wherein the at least one service providing condition includes an agreed purchase value for providing the first part of the service by the first operator network device using the first wireless technology.

30. The server of claim 17, wherein the information received from the first operator network device includes a suggested compensation associated with bandwidth to be provided.

31. The server of claim 17, wherein the information received from each of the plurality of second operator network devices includes an offer for compensation associated with bandwidth to be provided.

32. The server of claim 17, wherein the at least one service providing condition includes an agreed purchase value for providing the second part of the service to the user device by the second operator network device using the second wireless technology.
